(19) United States
(12) Patent Application Publication
(10) Pub. No.: US 2013/0244193 A1
(43) Pub. Date: Sep. 19, 2013

(54) System and Method for Orthodontic System

(71) Applicants: Nei-Chang Yu, Taipei (TW); Nai-Wen Yu, Taipei (TW)

(72) Inventors: Nei-Chang Yu, Taipei (TW); Nai-Wen Yu, Taipei (TW)

(21) Appl. No.: 13/888,676

(22) Filed: May 7, 2013

Related U.S. Application Data
(63) Continuation-in-part of application No. 12/466,205, filed on May 14, 2009.

(30) Foreign Application Priority Data
Jul. 10, 2008 (TW) 097212214

(51) Int. Cl. A61C 8/00; A61C 7/20; A61C 7/02

(52) U.S. Cl. CPC A61C 8/0096; A61C 7/02; A61C 7/20
USPC 433/3; 433/24

(57) ABSTRACT

An orthodontic fixture system includes a tap, a screw, a tool, and fixation wire. In a method of orthodontic fixation, a user manipulates the tool to drive the tap and screw. The tap is configured to first make a threaded hole in only a proximal wall of an alveolus bone. The screw is configured for firm insertion in the proximal wall of the alveolus bone through the hole made with the tap and to abut an inner surface of the distal wall of the alveolus bone in a non-damaging manner. The screw and fixation wire include cooperating structures to enable a user to readily apply both tension and torsional forces via mutual engagement of the screw and fixation wire and thus to one or more orthodontic elements attachable to patient teeth.

### RELATED APPLICATIONS

This application is a continuation-in-part of pending U.S. application Ser. No. 12/466,205 filed May 14, 2009 entitled Orthodontic System and which claims priority to Taiwanese Application 097212214 filed Jul. 10, 2008.

### FIELD OF INVENTION

The invention relates to methods of orthodontic fixation and orthodontic fixture systems. More particularly, the invention relates to methods of orthodontic fixation employing an orthodontic fixture system including a tap, a screw including a fixation aperture, fixation wire, and installation tools.

### BACKGROUND OF INVENTION

In a standard process for affixing an orthodontic fixation, a slit is made in gingival tissue with a knife, and a portion of the gingival tissue is flipped open. A hole is made in the alveolus bone with an electric dental engine. With the dental engine, a threaded body of a screw is then driven in the alveolus bone through the hole while a platform, neck and head of the screw extend outside the alveolus bone. An orthodontic wire and/or a spring are used to apply traction, for example to pull a tooth towards the orthodontic screw.

In a shortened process, the step of making a slit in the gingival tissue and the step of flipping open a portion of the gingival tissue of the standard process are sometimes omitted. That is, a hole is directly made in the gingival tissue and the alveolus bone with the threaded body then driven in with an electric dental engine.

### SUMMARY OF INVENTION

Embodiments are based at least in part on a new appreciation and understanding that a depth in the alveolus bone reached with the threaded body is critical. If the depth is insufficient, the threaded body will lack adequate support and be too weak to sufficiently pull the tooth via the orthodontic wire and/or the spring. If the depth is excessive, the threaded body might be driven into and through the alveolus bone so as to extend from the alveolus bone from the opposite side because of the high speed of the electric dental engine.

With the shortened process described above, there is also greater risk of necrosis of adjacent portions of the gingival tissue because it might be shredded with the orthodontic screw driven with the electric dental engine operated at high speed.

In both of the standard and shortened processes, the forces that can be exerted on the tooth with the orthodontic wire and/or the spring supported on the orthodontic screw are inadequate for at least certain applications. For example, torque cannot be readily exerted on the tooth with the existing orthodontic screw alone.

Accordingly, embodiments include methods of orthodontic fixation and orthodontic systems including a tap, a screw, fixation wire, and installation tools. A user can manipulate the tool to drive the tap and screw. The tap is configured to make a non-through hole in an alveolus bone. The screw is configured for firm insertion in the alveolus bone through the non-through hole made with the tap.

Other objectives, advantages and features of the invention will be apparent from the following description referring to the attached drawings.

### BRIEF DESCRIPTION OF DRAWINGS

The invention will be described via the detailed schematic illustration of embodiments referring to the drawings.

FIG. 1 is a schematic view of an orthodontic fixture system according to one embodiment.

FIG. 2 is a side view of a tap of the orthodontic fixture system of FIG. 1.

FIG. 3 is a side view of a screw of the orthodontic fixture system shown in FIG. 1.

FIG. 4 is a partial, perspective view of the screw shown in FIG. 3.

FIG. 5 is a partial, perspective view of a screw according to another embodiment.

FIG. 6 is a partial, perspective view of a screw according to another embodiment.

FIGS. 7A and 7B are schematic side views of embodiments of a tap and of a spring tied to a screw respectively and orthodontic fixation methods thereof.

FIG. 8 shows a patient's teeth subjected to orthodontia with the spring and screw shown in FIG. 7B and orthodontic fixation methods thereof.

FIG. 9 is shows a patient's teeth subjected to orthodontia with a first wire and the screw shown in FIG. 5 and orthodontic fixation methods thereof.

FIG. 10 is a perspective view of a first wire and a fixation wire connected to the screw shown in FIG. 5 and orthodontic fixation methods thereof via corresponding anatomical structure not shown for improved visibility.

### DETAILED DESCRIPTION OF EMBODIMENTS

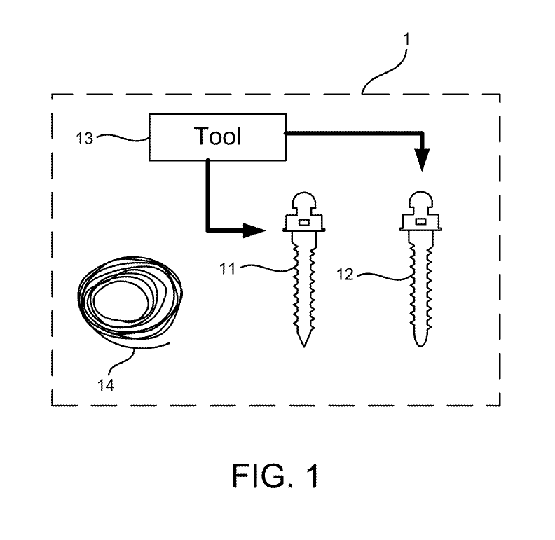

Reference will now be made to the drawings. All drawings are schematic in nature and are not to scale and in some views illustrates anatomical structure also in a schematic nature. Referring to FIG. 1, an orthodontic fixture system 1 includes a tap 11, a selection of screws 12, a tool 13, and fixation wire 14 according to one embodiment. The orthodontic fixture system 1 is configured for methods of orthodontic fixation of a patient's teeth. In various embodiments, tool 13 is a screwdriver or wrench configured to engage the tap 11 and screw 12 so as to apply a rotation force and optionally also a longitudinal force. The tool 13 is manually driven in some embodiments and in other embodiments is powered, which can include electrical power from a utility service or batteries. An engagement surface of the tool 13 is configured to cooperatively engage with associated taps 11 and screws 12.

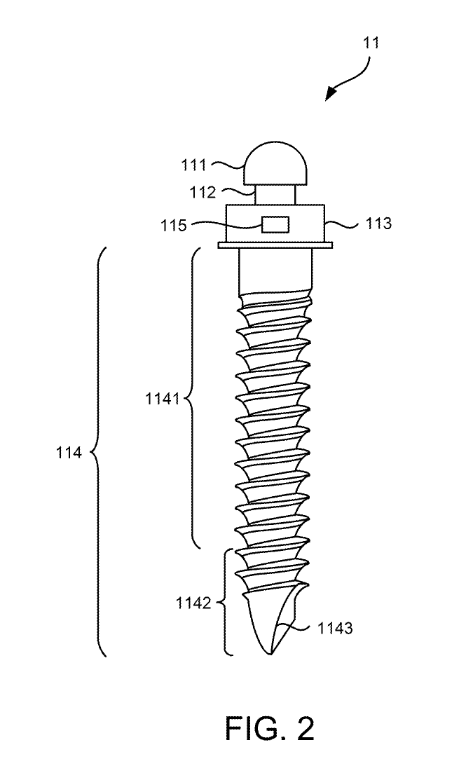

Referring to FIG. 2, embodiments of the tap 11 include a threaded body 114, a platform 113 on the threaded body 114, a head 111 and a neck 112 between the platform 113 and the head 111. The diameter of the neck 112 is smaller than diameters of the platform 113 and the head 111. The neck 112 is made by making a groove around the tap 11. The threaded body 114 includes a thread 1141 formed thereon and a blade 1143 formed at a tip 1142 thereof. The tap 11 thus comprises a cutting and threading capability, for example so as to form a threaded hole or passage in bone tissue upon suitable driving force from the tool 13. In some embodiments, the tap 11 includes a fixation aperture 115 transversely defined in the platform 113.

The tap 11 is preferably made of a hard and tough material suitable for use in the animal body. In some embodiments, the tap 11 is made of stainless steel and in other embodiments is made of a titanic alloy. The tap 11 is preferably made of non-toxic materials, however need not be made of biocompatible materials in all embodiments as the tap 11 is not necessarily configured for extended residence within an animal body, but only for relatively brief use during execution of methods of orthodontic fixation as will be described in greater detail below. In some embodiments, the tap 11 is configured for multiple uses and includes the ability to be cleaned and sterilized between uses.

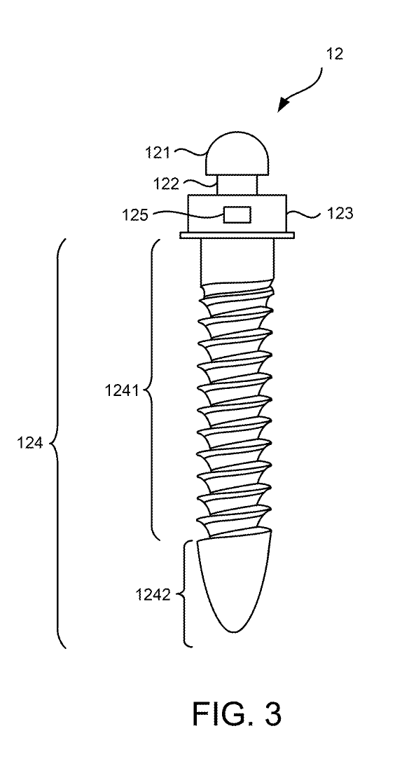

Referring to FIG. 3, embodiments of the screw 12 include a threaded body 124, a platform 123 on the threaded body 124, a head 121 and a neck 122 between the platform 123 and the head 121. The diameter of the neck 122 is smaller than diameters of the platform 123 and the head 121. The neck 122 is made by making a groove around the screw 12. A fixation aperture 125 is transversely defined in the platform 123. The fixation aperture 125 is a through hole configured to receive fixation wire 14 in a manner that will be described in greater detail below. The threaded body 124 includes a thread 1241 formed thereon and a rounded tip 1242 thereof.

The screw 12 is preferably made of biologically compatible materials, such as stainless steel or biologically compatible titanium alloys. The screw 12 is configured for extended residence in the animal body. In one embodiment, a variety of screws 12 are provided of varying dimensions and/or materials. In some embodiments, screws 12 are provided in various lengths to accommodate differing dimensions of a corresponding patient's anatomical structure. In some embodiments, screws 12 are provided in various materials, for example to accommodate a patient's allergy to certain materials. Embodiments of orthodontic fixation methods include selecting an appropriate screw 12 from a plurality of different screws 12 appropriate to a particular application.

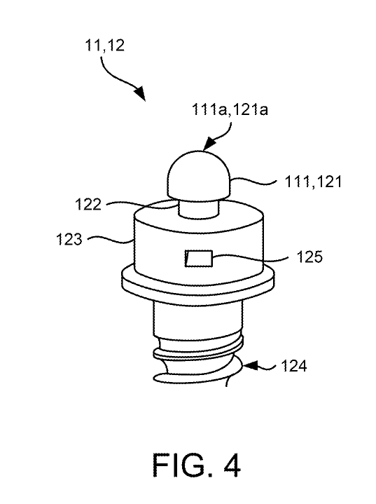

Referring to FIG. 4, embodiments of the head 111 of the tap 11 include a dome 111a on the top while the head 121 of the screw 12 includes a dome 121a on the top according to one embodiment. A corresponding tool 13 would have complementary mating engagement structures.

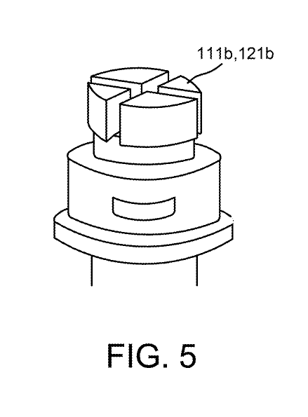

Referring to FIG. 5, the head 111 of the tap 11 include a circular disc and similar is the head 121 of the screw 12 according to another embodiment. Radial slits are defined in the head 111, thus dividing the head 111 into blocks 111b. Radial slits are defined in the head 121 of the screw 12, thus dividing the head 121 into blocks 121b. A corresponding tool 13 would have complementary mating engagement structures.

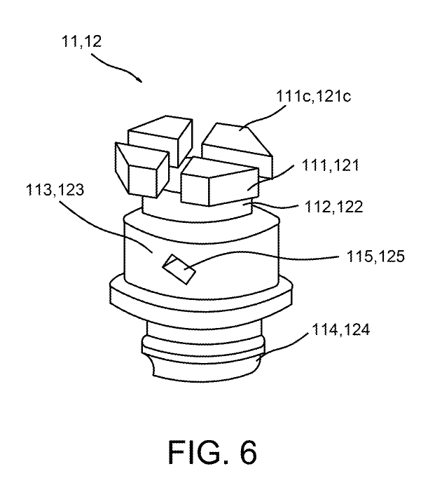

Referring to FIG. 6, the head 111 of the tap 11 is a hexagonal disc and similar is the head 121 of the screw 12 according to another embodiment. Radial slits are defined in the head 111, thus dividing the head 111 into blocks 111c. Radial slits are defined in the head 121, thus dividing the head 121 into blocks 121c. A corresponding tool 13 would have complementary mating engagement structures.

In the embodiments illustrated and described with respect to FIGS. 2-5, the fixation apertures 115 and 125 are generally rectangular cross-section through-going holes. Flat interior surfaces of the fixation apertures 115 and 125 of these embodiments are arranged substantially parallel or perpendicular to a longitudinal axis of the tap 11 or screw 12. The fixation apertures 115 and 125 are oriented in a different direction in the embodiment illustrated and described with respect to FIG. 6 than in other embodiments. More particularly, in the embodiment of the fixation apertures 115 and 125 illustrated and described with respect to FIG. 6, flat interior surfaces of the fixation apertures 115 and 125 are rotated from substantially parallel or perpendicular to a longitudinal axis of the tap 11 or screw 12 along a generally transverse axis of the tap 11 or screw 12.

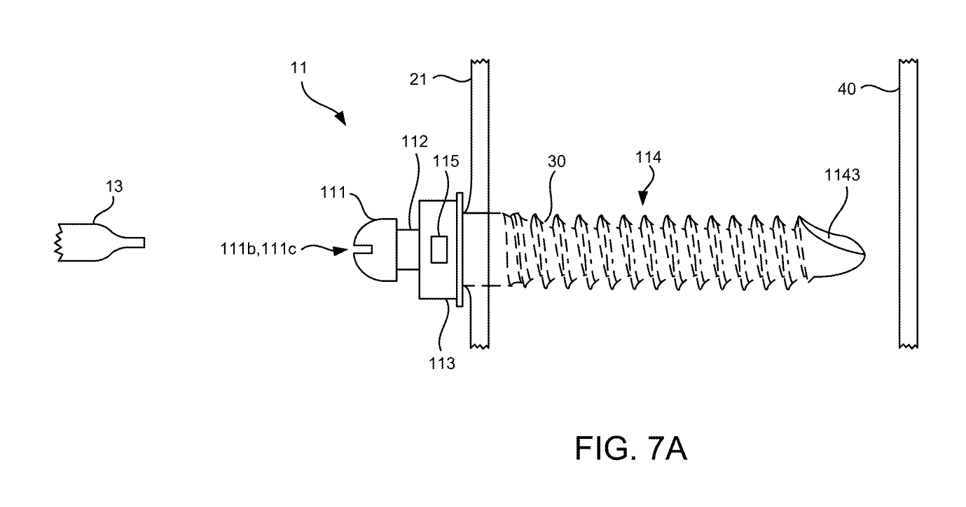

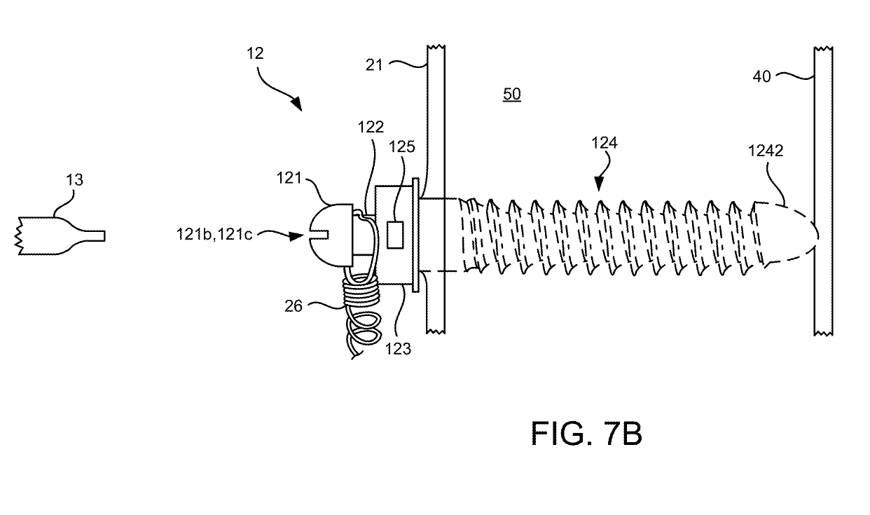

In one embodiment of a method of orthodontic fixation as shown in FIG. 7A, a dentist employs an appropriate embodiment of tool 13 to apply a rotation force and, optionally, also a longitudinal inwards force so as to drive the tap 11 by the head 111b or 111c, thus making an at least partially threaded hole 30 in the alveolus bone with the blade 1143 and thread 1141 of the threaded body 114 of the tap 11. While penetrating a proximal wall 21 of the alveolus bone, the dentist encounters resistance. On penetrating the proximal wall 21 of the alveolus bone, the dentist feels a drop in the resistance. Now, the dentist removes the tap 11 from the alveolus bone, with greatly reduced risk of penetrating a distal wall 40 of the alveolus bone with the tap 11. The contour of the partially threaded hole 30 in the alveolus bone corresponds generally to the outer contour or envelope of the tap 11 at its furthest penetration into the alveolus bone.

Referring to FIG. 7B, in one embodiment, the dentist employs the tool 13 to drive the screw 12 by the head 121b or 121c, thus driving the threaded body 124 of the screw 12 into and through the proximal wall 21 of the alveolus bone generally into the partially threaded hole 30 previously made with the blade 1143 and the thread 1141 of the tap 11. While driving the threaded body 124 of the screw 12 into the marrow 50 of the alveolus bone, the dentist encounters resistance. On reaching the distal wall 40 of the alveolus bone, the dentist feels marked growth in the resistance. Now, the dentist ceases advancing the screw 12. It is difficult for the dentist to unintentionally penetrate the distal wall 40 of the alveolus bone with the rounded tip 1242 of the threaded body 124 of the screw 12 as the screw 12 lacks the cutting blade 1143 of the tap 11.

FIG. 7B also shows that in one embodiment the dentist attaches wire formed into a spring 26 to the portion of the screw 12 exposed outside the proximal wall 21 of the alveolus bone. In one embodiment, the spring 26 is attached to the neck 122 of the screw 12. FIG. 7B also shows that in one embodiment the dentist advances the screw 12 sufficiently that the rounded tip 1242 engages in non-damaging contact with the distal wall 40 of the alveolus bone. This embodiment provides the advantage that the installed screw 12 engages with both the proximal wall 21 and the distal wall 40 of the alveolus bone. In this embodiment, the screw 12 is supported at two opposite and displaced ends via engagement with the proximal wall 21 and the distal wall 40 and thus obtains improved structural support to better resist off-axis forces from the spring 26.

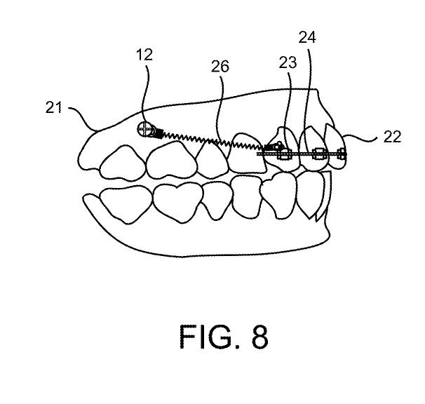

Referring to FIG. 8, a first wire 24 is provided. The first wire 24 is square in a cross-sectional view so that it can be used as a twist wire for exerting a torque. Moreover, the first wire 24 is elastic so that it can be used as a tensile wire for exerting a tensile force. Furthermore, the first wire 24 is made of an appropriate rigidity so that it can be bent to obtain a desired direction of a tensile force.

In one embodiment of a method of orthodontic fixation, the dentist attaches several orthodontic elements 23 to a patient's teeth 22 and connects the first wire 24 to the orthodontic elements 23, thus connecting the orthodontic elements 23 to one another. Then, the dentist ties an end of a spring 26 to one of the orthodontic elements 23 and another end of the spring 26 to the neck 122 of the screw 12, thus pulling the teeth 22 towards the screw 12.

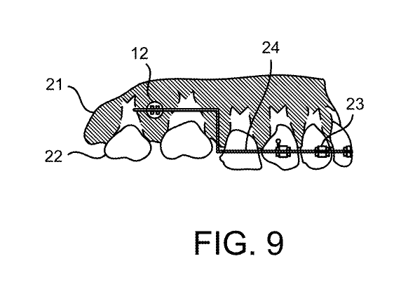

Referring to FIG. 9, in another embodiment of a method of orthodontic fixation, the dentist attaches the orthodontic elements 23 to the teeth 22. Then, the dentist ties an end of the first wire 24 to the orthodontic elements 23 and another end of the first wire 24 to a selected one of the blocks 121b. The greater the number of blocks 121b, the easier a desired direction of the first wire 24 can be reached. The dentist pulls and bends the first wire 24 before tying it, thus providing a tensile force in a desired direction. Hence, the dentist pulls the teeth 22 towards the screw 12 without having to use any spring.

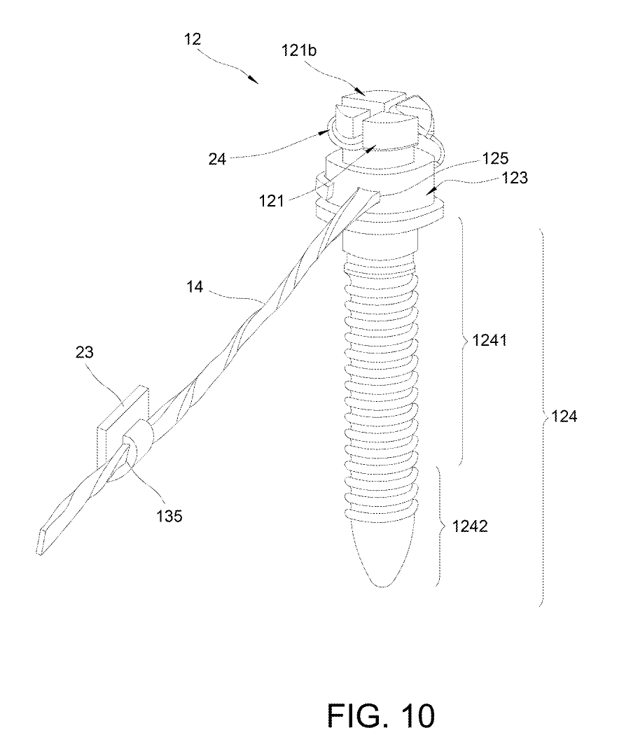

Referring to FIG. 10, in one embodiment of a method of orthodontic fixation, the screw 12 is affixed as previously described and a first wire 24 is tied to the head 121b of the screw 12. One end of a fixation wire 14 is connected to one or more orthodontic elements 23 and the fixation wire 14 is twisted as extending from the one or more orthodontic elements 23. An opposite end of the fixation wire 14 is driven through the fixation aperture 125 of the screw 12 and tied to a selected one of the blocks 121b.

In this embodiment, the fixation wire 14 is rectangular in cross-section. In other embodiments, the fixation wire 14 is triangular, oblong, or other sectional shapes, according to the requirements of particular applications. The fixation wire 14 is sized and configured to extend longitudinally through the fixation aperture 125, however to resist rotation or turning within the fixation aperture 125 via material impingement and interference therewith. A rectangular cross-section of the fixation wire 14 and appropriate dimensions enable a torsional force to be applied to the fixation wire 14 via engagement with the screw 12. In a like manner, the orthodontic element 23 also comprises a fixation aperture 135 which is sized and configured to receive an end of the fixation wire 14, but resist rotation of the fixation wire 14 with respect to the fixation aperture 135. Thus, a torque is exerted on teeth 22 attached to the orthodontic elements 23 via the one or more orthodontic elements 23 with the fixation wire 14 as engaged with the fixation aperture 125 of the screw 12.

Embodiments of methods of orthodontic fixation and orthodontic fixture systems 1 exhibit several advantages. Firstly, there is greatly reduced risk of necrosis of the gingival tissue. This is because the dentist manually drives the tap 11 into the alveolus bone through the gingival tissue with the tool 13 and can stop the tap 11 before shredding any portion of the gingival tissue.

Secondly, there is greatly reduced risk of breaching the threaded body 71 because the tap 11 is configured to make the partially threaded hole 30 in the proximal wall 21 of the alveolus bone and the marrow 50, but not impinge on or damage the distal wall 40. The screw 12 of selectable lengths is driven through the proximal wall 21 into the marrow 50 of the alveolus bone and stopped on reaching the distal wall 40 of the alveolus bone.

Thirdly, appropriate depth in the alveolus bone reached with the screw 12 is facilitated because the screw 12 is stopped on the moment when the rounded tip 1243 of the screw 12 is abutted against the distal wall 40 of the alveolus bone. The support of the screw 12 by both the proximal and distal walls 30, 40 of the alveolus bone is more reliable than the support of a screw by only the first wall 21 and marrow 50 of the alveolus bone. At the same time, there greatly reduced risk of penetrating the distal wall 40 of the alveolus bone with the rounded tip 1243 of the screw 12.

Fourthly, a torque can be exerted on the teeth 22 via orthodontic elements 23 using the fixation wire 14 together with the screw 12.

What is claimed is:

1. A method of orthodontic fixation comprising:
forming a hole through a proximal wall of an alveolus bone and through at least a portion of adjacent marrow; and
fixing an orthodontic screw into the hole so as to extend to engage a proximal surface of an adjacent distal wall of the alveolus bone in a non-damaging manner.

2. The method of claim 1, wherein forming the hole comprises forming a partially threaded hole.

3. The method of claim 1, wherein forming the hole and fixing the orthodontic screw comprises applying a rotation force via a tool to a tap and the screw respectively.

4. The method of claim 3, wherein applying the rotation force is performed manually.

5. The method of claim 1, wherein fixing the orthodontic screw comprises engaging the screw with both the proximal and distal walls of the alveolus bone such that the screw is structurally supported at each of two opposite ends of the screw.

6. The method of claim 1, further comprising connecting the screw to at least one orthodontic element with at least one of a spring and wire.

7. The method of claim 6, further comprising engaging a fixation wire with a fixation aperture of the screw such that the fixation wire is inhibited from rotating with respect to the screw.

8. The method of claim 7, further comprising twisting the fixation wire at least between the screw and the at least one orthodontic element and engaging the fixation wire with a fixation aperture of the at least one orthodontic element such that the fixation wire is inhibited from rotating with respect to the at least one orthodontic element such that torque is applied between the screw and the at least one orthodontic element.

9. The method of claim 1, further comprising selecting the screw from a plurality of screws of differing lengths such that the screw abuts both the proximal wall and the distal wall of the alveolus bone in non-damaging manners.

10. An orthodontic fixture system comprising:
a tap configured to form a hole in an alveolus bone wherein the tap comprises a body, a platform formed on the body, a head, a neck formed between the platform and the head, a thread formed on the body, and a cutting blade formed at a distal tip of the tap;
a screw configured for insertion in the alveolus bone through the hole made with the tap wherein the screw comprises a body, a platform formed on the body, a fixation aperture transversely extending through the platform, a head, a neck formed between the platform and the head, a thread formed on the body, and a rounded tip; and
fixation wire sized and configured to extend longitudinally through the fixation aperture of the screw such that the fixation wire is inhibited from rotating with respect to the fixation aperture such a torque force is exertable between the fixation aperture and the fixation wire.

11. The orthodontic fixture system of claim 10, further comprising a tool configured to engage with the head of the tap and of the screw so as to apply a rotation force thereto.

12. The orthodontic system according to claim 10, wherein the tap and screw are made of different materials.

13. The orthodontic system according to claim 12, wherein the tap is made of stainless steel while the screw is made of a titanic alloy.
